(19) United States
(12) Patent Application Publication
(10) Pub. No.: US 2026/0093734 A1
(43) Pub. Date: Apr. 2, 2026

(54) SYSTEMS AND METHODS FOR NATURAL LANGUAGE BASED CODING ASSISTANCE WITH ENTERPRISE CONTEXT

(71) Applicant: Amazon Technologies, Inc., Seattle, WA (US)

(72) Inventors: Rajdeep MUKHERJEE, San Jose, CA (US); Ajay MISHRA, Santa Clara, CA (US); Qing SUN, Sunnyvale, CA (US); Mehdi SHOJAIE, Seattle, WA (US); Dejiao ZHANG, Jersey City, NJ (US); Arash MASHHADI FARAHANI, Weehawken, NJ (US); Xiaofei MA, New York, NY (US); Anoop DEORAS, San Jose, CA (US)

(21) Appl. No.: 18/899,446

(22) Filed: Sep. 27, 2024

(51) Int. Cl. G06F 16/334; G06F 16/338; G06F 40/30

(52) U.S. Cl. CPC G06F 16/3344; G06F 16/3347; G06F 16/338; G06F 40/30

(57) ABSTRACT

Techniques for natural language based chat are described. In some examples, a chat service receive a request to answer a natural language query (NLQ), generate one or more embedding vectors for the NLQ, performs a search of a vector database having information regarding one or more of enterprise context, natural language summaries of enterprise context, embedding vectors for the enterprise context, and embedding vectors for natural language summaries of the enterprise context according to the request to generate a search result, augmenting the NLQ using the search result, predicts a response for the NLQ using the search result augmented NLQ, and provides the predicted response in the chat.

### BACKGROUND

Machine learning refers to a discipline by which computer systems can be trained to recognize patterns through repeated exposure to training data. In unsupervised learning, a self-organizing algorithm learns previously unknown patterns in a data set without any provided labels. In supervised learning, this training data includes an input that is labeled (either automatically, or by a human annotator) with a “ground truth” of the output that corresponds to the input. A portion of the training data set is typically held out of the training process for purposes of evaluating performance of the trained model. The learned parameters of the model can be considered as an encoding of meaningful patterns in the training data, such that the trained model can then recognize these same patterns in new data. The use of a trained model in production is often referred to as “inference,” during which the model receives new data that was not in its training data set and provides an output based on its learned parameters. The training and validation process may be repeated periodically or intermittently, by using new training data to refine previously learned parameters of a production model and deploy a new production model for inference, in order to mitigate degradation of model accuracy over time. In contrast to machine learning (ML), artificial intelligence (AI) refers to a human perception of a computer system as possessing a capability typically considered to require intelligence. Generative AI, or “GenAI”, refers to a class of ML models that are able to produce net new content as their outputs, for example text, images, and video.

### BRIEF DESCRIPTION OF DRAWINGS

Various examples in accordance with the present disclosure will be described with reference to the drawings, in which:

FIG. 1 illustrates examples of systems for an integrated development environment to provide a chat functionality with extended context.

FIG. 2 illustrates examples of a system that provides natural language query support.

FIG. 3 illustrates examples of generating an answer to a natural language query.

FIG. 4 is a flow diagram illustrating operations of methods for providing a natural language-based chat for coding tasks according to some examples.

FIG. 5 illustrates examples of a graphical user interface for an IDE.

FIG. 6 is a flow diagram illustrating operations of methods for providing a natural language-based chat for coding tasks according to some examples.

FIG. 7 illustrates an example cloud provider network environment according to some examples.

FIG. 8 is a block diagram of an example cloud provider network that provides a storage service and a hardware virtualization service to users according to some examples.

FIG. 9 is a block diagram illustrating an example computing device that can be used in some examples.

### DETAILED DESCRIPTION

Developers often ask natural language questions for their coding tasks, such as code generation (for example, write a function that uploads data to storage bucket using a particular wrapper), code summarization, an explanation related to private packages for learning or knowledge gathering (for example, “what does a private package do?”), code debugging or optimization, or code analysis tasks. However, existing integrated development environments (IDEs) typically lack the context-aware capabilities needed to assist developers with enterprise-specific code and libraries, forcing them to rely on time-consuming manual searches or internal forums for answers.

The technology of the present disclosure addresses these challenges by providing a natural language-based chat interface that enables developers to interact with their enterprise codebase efficiently. This system leverages advanced techniques in code analysis, natural language processing, and information retrieval to offer context-aware assistance for various coding tasks. By incorporating enterprise-specific context, the technology allows developers to ask natural language questions about their codebase and receive accurate, relevant responses. This approach significantly enhances IDE-based code assistance, streamlining development workflows and enabling developers to tap into their organization's collective knowledge and resources directly from their coding environment.

The system's ability to provide context-aware assistance is enabled by its comprehensive understanding of the enterprise codebase. During the initial ingestion process, the system performs in-depth analysis of the source code, extracting not just the code itself, but also the structural and semantic relationships between different components. This includes identifying function and class-level entities, mapping dependencies and interactions between modules, and capturing high-level design patterns and architectural principles. The system further enhances this understanding by generating natural language summaries that describe the purpose and functionality of the extracted code chunks. By indexing both the code and these natural language summaries, the system is able to create a rich knowledge base that reflects the enterprise's unique codebase and coding practices. When a developer poses a natural language query, the system leverages this contextual awareness to interpret the query, identify relevant code segments, and provide responses tailored to the organization's specific implementation details and design choices. This enterprise-aware approach enables the system to deliver significantly more relevant and actionable assistance compared to generic code exploration tools.

Accordingly, the present disclosure relates to methods, apparatus, systems, and non-transitory computer-readable storage media for natural language chat for coding tasks.

In some systems, these questions are asked in a company's internal forum. This requires time for a response to be generated by someone else (if generated at all) and solely relies on that other person's knowledge which may be incomplete.

In other systems, chat functionality within an integrated development environment (IDE) is confined to inline code generation and addressing questions related to the active file(s) and open tabs. Developers can seek explanations about specific elements within the file, such as its purpose, functionality, or algorithmic implementation, and inquire about potential refactoring or optimization recommendations. However, the “understanding” is limited to the scope of the active file, and it lacks comprehension of the broader context, including dependencies, the role played by the file or class within the application, or its interactions with other components. As a result, while these types of chats provide valuable insights and assistance within the confines of the active file, their capabilities for understanding the broader context of the codebase remain constrained.

Examples detailed herein improve IDE chat functionality to utilize a larger context (e.g., information from an enterprise, a group within an enterprise, etc.). By doing so, the larger context can be utilized in allowing developers to not only ask questions about their project, but also the libraries indexed as a part of the enterprise context. This integration enhances the depth and breadth of assistance available within the IDE, enabling developers to tap into the collective knowledge and resources of their organization while coding. Whether seeking advice on project-specific implementations or exploring the capabilities of enterprise libraries, users can leverage the expanded context to make informed decisions and streamline their development workflows further.

With expanded context and understanding, users can comprehend the purpose, structure, and design patterns employed within the codebase. They can provide explanations of the code to developers, aiding in tasks such as debugging, refactoring (optimization), or feature development. Users can answer questions regarding the codebase or project, ranging from “What is the purpose of this module/class?” to “How does this component interact with external systems?” or “What design patterns are prevalent in this codebase?”

With expanded context and understanding, the system can analyze the existing codebase and generate suggestions or code snippets that are contextually relevant to the user's current task. This could include recommending design patterns, suggesting code optimizations, or offering template code for common tasks. Users can ask questions like, “Can you suggest a more efficient way to implement this functionality?”, “Provide an example of how to use this library in our codebase”, or “Generate a code snippet for handling error logging.”

With expanded context and understanding, users can undertake actions to improve the codebase's structure, performance, or maintainability. This may involve refactoring code to adhere to best practices, upgrading dependencies to newer versions, or rearchitecting components to improve scalability. Users can ask questions like, “What are the potential areas for refactoring in this codebase?”, “Is it safe to upgrade this library to the latest version?”, or “How can we rearchitect this module to better support concurrent requests?”

With expanded context and understanding, users can locate relevant code sections, functions, or classes within the project. They can utilize features like “Go to Definition,” “Find References,” and “Navigate to Symbol” to jump to the respective locations in the codebase. Users can also search for specific keywords to find occurrences throughout the code or locate function definitions. Questions users may ask include, “Where is the implementation of this feature located?”, “What are the dependencies of this module?”, or “Show me all the files related to user authentication.”

With expanded context and understanding, users can perform focused searches within the codebase to quickly locate relevant components. They can search based on function names, file names, folder structures, or even specific keywords within the code. Questions users can ask include, “Where is the implementation of this function located?”, “Which files contain references to this class?”, “Show me all files related to authentication”, or “Find occurrences of a specific variable name throughout the codebase.”

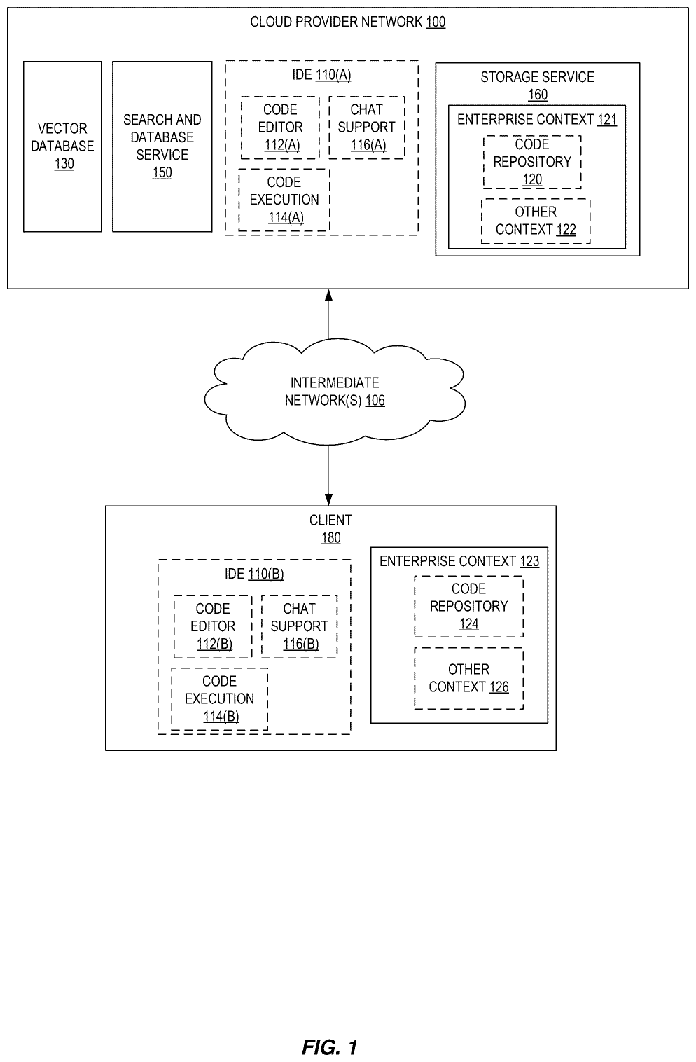

FIG. 1 illustrates examples of systems for an integrated development environment to provide chat functionality with extended context. As shown an IDE may be a part of a client 180 (shown as IDE 110(B)) and/or a part of a cloud provider network 100 offering (shown as IDE 110(A)). The IDE 110(A) or 110(B) allows a user to edit code using a code editor 112(A) or 112(B). In some examples, the user can also execute that code using code execution logic 114(A) or 114(B). Other IDE functionality may be provided. The IDE 110(A) or 110(B) also provides natural language query (NLQ) chat support 116(A) or 116(B) that allows a user to chat with the IDE to ask NLQs. Examples of how that support works are detailed below. The NLQ chat support 116(A) or 116(B) takes in enterprise context 121 such as code from a code repository 120 (e.g., code for an enterprise, code for an organization within an enterprise, public data, etc.) and/or other context 122 (e.g., known best practices documents, product documentation, existing documentation for code, structure information for the enterprise and/or organization, etc.) and uses this context to generate a result to a NLQ. In some examples, a storage service 160 may be used to maintain this context. This information may also be maintained at the client 180 (see enterprise context 123 such as code repository 124 and other context 126). In some examples, the NLQ chat support 116(A) or 116(B) is not a part of an IDE 110 (e.g., is a separate, more general service or incorporated into a different service).

The cloud provider network 100 also includes a search and database service 150. In some examples, the search and database service 150 provides capabilities for search, analytics, security monitoring, and observability applications. The search engine allows for a search of a vector database 130.

Information comes in many forms unstructured data, like text documents, rich media, and audio, and structured data, like geospatial coordinates, tables, and graphs. Embeddings may be used to encode all types of data into vectors. These vectors are data points in a high-dimensional space that capture the meaning and context of an asset, allowing search tools to find similar assets by searching for neighboring data points. The vector database 130 allows for the storage and indexing of vectors and associated metadata. In examples detailed herein, the vector database 130 is used to store information about the context of the code from a code repository 120/124 and/or other context 122/126.

The NLQ chat support 116(A) or 116(B) uses contextual information from the vector database 130 that is similar to a received NLQ to generate a response to the NLQ.

The cloud provider network 100 (also referred to herein as a provider network, service provider network, etc.) provides users with the ability to use one or more of a variety of types of computing-related resources such as compute resources (e.g., executing virtual machine (VM) instances and/or containers, executing batch jobs, executing code without provisioning servers), data/storage resources (e.g., object storage, block-level storage, data archival storage, databases and database tables, etc.), network-related resources (e.g., configuring virtual networks including groups of compute resources, content delivery networks (CDNs), Domain Name Service (DNS)), application resources (e.g., databases, application build/deployment services), access policies or roles, identity policies or roles, machine images, routers and other data processing resources, etc. These and other computing resources can be provided as services, such as a hardware virtualization service that can execute compute instances, a storage service that can store data objects, etc. The users (or “customers”) of cloud provider networks 100 can use one or more user accounts that are associated with a customer account, though these terms can be used somewhat interchangeably depending upon the context of use. Cloud provider networks are sometimes “multi-tenant” as they can provide services to multiple different customers using the same physical computing infrastructure; for example, virtual machine instances may be concurrently hosted for different customers using a same underlying physical host computing device.

Users can interact with a cloud provider network 100 across one or more intermediate networks 106 (e.g., the internet) via one or more interface(s), such as through use of application programming interface (API) calls, via a console implemented as a website or application, etc. An API refers to an interface and/or communication protocol between a client and a server, such that if the client makes a request in a predefined format, the client should receive a response in a specific format or initiate a defined action. In the cloud provider network context, APIs provide a gateway for customers to access cloud infrastructure by allowing customers to obtain data from or cause actions within the cloud provider network, enabling the development of applications that interact with resources and services hosted in the cloud provider network. APIs can also enable different services of the cloud provider network to exchange data with one another. The interface(s) can be part of, or serve as a front-end to, a control plane of the cloud provider network 100 that includes “backend” services supporting and enabling the services that can be more directly offered to customers.

Thus, a cloud provider network (or just “cloud”) typically refers to a large pool of accessible virtualized computing resources (such as compute, storage, and networking resources, applications, and services). A cloud can provide convenient, on-demand network access to a shared pool of configurable computing resources that can be programmatically provisioned and released in response to customer commands. These resources can be dynamically provisioned and reconfigured to adjust to variable load. Cloud computing can thus be considered as both the applications delivered as services over a publicly accessible network (e.g., the Internet, a cellular communication network) and the hardware and software in cloud provider data centers that provide those services.

A cloud provider network can be formed as a number of regions, where a region is a geographical area in which the cloud provider clusters data centers. Each region includes multiple (e.g., two or more) availability zones (AZs) connected to one another via a private high-speed network, for example a fiber communication connection. An AZ (also known as a “zone”) provides an isolated failure domain including one or more data center facilities with separate power, separate networking, and separate cooling from those in another AZ. A data center refers to a physical building or enclosure that houses and provides power and cooling to servers of the cloud provider network. Preferably, AZs within a region are positioned far enough away from one another so that a natural disaster (or other failure-inducing event) should not affect or take more than one AZ offline at the same time.

Users can connect to an AZ of the cloud provider network via a publicly accessible network (e.g., the Internet, a cellular communication network), e.g., by way of a transit center (TC). TCs are the primary backbone locations linking users to the cloud provider network and can be collocated at other network provider facilities (e.g., Internet service providers (ISPs), telecommunications providers) and securely connected (e.g., via a VPN or direct connection) to the AZs. Each region can operate two or more TCs for redundancy. Regions are connected to a global network which includes private networking infrastructure (e.g., fiber connections controlled by the cloud provider) connecting each region to at least one other region. The cloud provider network can deliver content from points of presence (or “POPs”) outside of, but networked with, these regions by way of edge locations and regional edge cache servers. This compartmentalization and geographic distribution of computing hardware enables the cloud provider network to provide low-latency resource access to users on a global scale with a high degree of fault tolerance and stability.

To provide these and other computing resource services, cloud provider networks 100 often rely upon virtualization techniques. For example, virtualization technologies can provide users the ability to control or use compute resources (e.g., a “compute instance,” such as a VM using a guest operating system (O/S) that operates using a hypervisor that might or might not further operate on top of an underlying host O/S, a container that might or might not operate in a VM, a compute instance that can execute on “bare metal” hardware without an underlying hypervisor), where one or multiple compute resources can be implemented using a single electronic device. Thus, a user can directly use a compute resource (e.g., provided by a hardware virtualization service) hosted by the provider network to perform a variety of computing tasks. Additionally, or alternatively, a user can indirectly use a compute resource by submitting code to be executed by the provider network (e.g., via an on-demand code execution service), which in turn uses one or more compute resources to execute the code-typically without the user having any control of or knowledge of the underlying compute instance(s) involved.

As described herein, one type of service that a provider network may provide may be referred to as a “managed compute service” that executes code or provides computing resources for its users in a managed configuration. Examples of managed compute services include, for example, an on-demand code execution service, a hardware virtualization service, a container service, or the like.

An on-demand code execution service (referred to in various examples as a function compute service, functions service, cloud functions service, functions as a service, or serverless computing service) can enable users of the cloud provider network 100 to execute their code on cloud resources without having to select or manage the underlying hardware resources used to execute the code. For example, a user can use an on-demand code execution service by uploading their code and use one or more APIs to request that the service identify, provision, and manage any resources required to run the code. Thus, in various examples, a “serverless” function can include code provided by a user or other entity—such as the provider network itself—that can be executed on demand. Serverless functions can be maintained within the provider network by an on-demand code execution service and can be associated with a particular user or account or can be generally accessible to multiple users/accounts. A serverless function can be associated with a Uniform Resource Locator (URL), Uniform Resource Identifier (URI), or other reference, which can be used to invoke the serverless function. A serverless function can be executed by a compute resource, such as a virtual machine, container, etc., when triggered or invoked. In some examples, a serverless function can be invoked through an application programming interface (API) call or a specially formatted HyperText Transport Protocol (HTTP) request message. Accordingly, users can define serverless functions that can be executed on demand, without requiring the user to maintain dedicated infrastructure to execute the serverless function. Instead, the serverless functions can be executed on demand using resources maintained by the cloud provider network 100. In some examples, these resources can be maintained in a “ready” state (e.g., having a pre-initialized runtime environment configured to execute the serverless functions), allowing the serverless functions to be executed in near real-time.

A hardware virtualization service (referred to in various implementations as an elastic compute service, a virtual machines service, a computing cloud service, a compute engine, or a cloud compute service) can enable users of the cloud provider network 100 to provision and manage compute resources such as virtual machine instances. Virtual machine technology can use one physical server to run the equivalent of many servers (each of which is called a virtual machine), for example using a hypervisor, which can run at least partly on an offload card of the server (e.g., a card connected via PCI or PCIe to the physical CPUs) and other components of the virtualization host can be used for some virtualization management components. Such an offload card of the host can include one or more CPUs that are not available to user instances, but rather are dedicated to instance management tasks such as virtual machine management (e.g., a hypervisor), input/output virtualization to network-attached storage volumes, local migration management tasks, instance health monitoring, and the like). Virtual machines are commonly referred to as compute instances or simply “instances.” As used herein, provisioning a virtual compute instance generally includes reserving resources (e.g., computational and memory resources) of an underlying physical compute instance for the client (e.g., from a pool of available physical compute instances and other resources), installing or launching required software (e.g., an operating system), and making the virtual compute instance available to the client for performing tasks specified by the client.

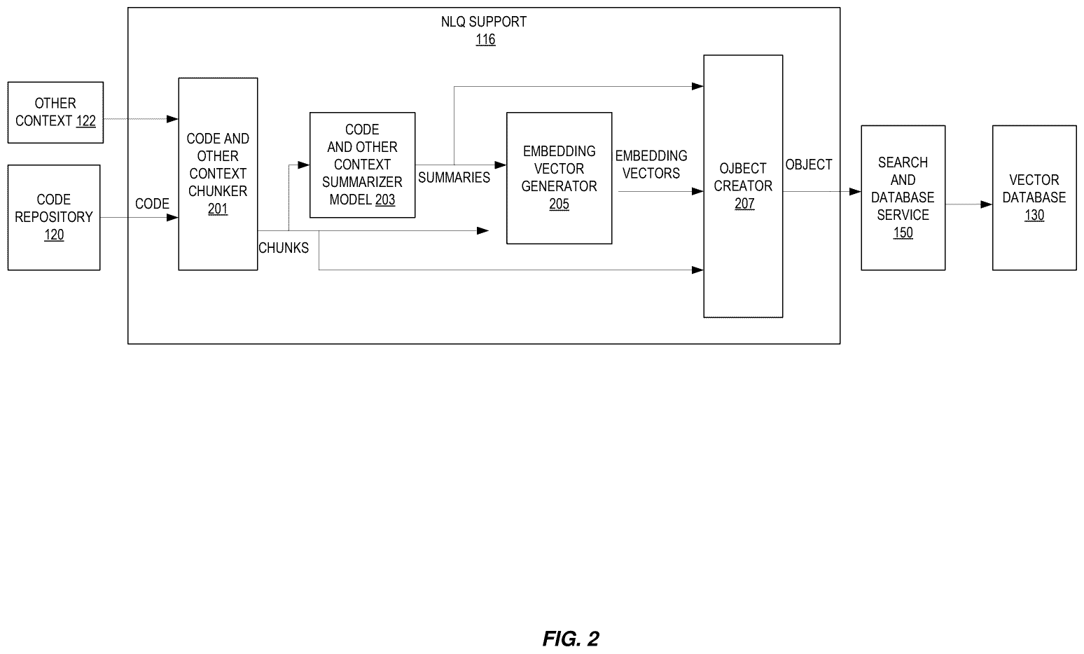

FIG. 2 illustrates examples of a system that provides natural language query support. In some examples, FIG. 2 illustrates examples of NLQ chat support 116. Note that NLQ chat support 116 is coupled to one or more other services in this illustration.

A code chunker 201 breaks down code from code repository 120 (e.g., maintained by storage service 160) into smaller segments (chunks) and/or other context 122. In some examples, the code chunker 201 performs chunking using an abstract syntax tree (AST) to generate a structured representation of the input code and/or other context as chunks. In some examples, functions, classes, docstrings, etc. are extracted and function-level and class-level chunks are created. For function-level chunks, the parent class definition may be included to preserve class context.

In some examples, a repository map is also created by the code chunker 201. A repository map contains a list of the files in a repository along with key symbols such as a class signature, or a function signature, which are defined in each file. The class or function content itself is not included in a repository map.

A sample file contains the following text:

```
template/cdk/app.py
import aws_cdk as cdk
from aws_cdk.aws_ec2 import CfnSecurityGroupIngress as ec2
from aws_cdk import Stack
class SelectivePorts(cdk.Stack): def
  init_{——}(self):
    pass
  def non_conformant_1( ):
    ec2(Stack, ‘rIngress2’, ip_protocol=‘tcp’,
    cidr_ipv6=‘X:x:X:x:X:x:X:X/PORT’)
```

An example of a repository mapping for the sample file is as follows:

```
template/cdk/app.py
class SelectivePorts(cdk.Stack):
  def _{——}init_{——}(self):
  def non_conformant_1( ):
```

In the above code, an example of a function-level chunk is:

```
def non_conformant_1( ):
  ec2(Stack, ‘rIngress2’, ip_protocol=‘tcp’,
  cidr_ipv6=‘X:x:X:x:X:x:X:X/PORT’)
```

An example of a class-level chunk is:

```
class SelectivePorts(cdk.Stack): def
  init_{——}(self):
    pass
  def non_conformant_1( ):
    ec2(Stack, ‘rIngress2’, ip_protocol=‘tcp’,
    cidr_ipv6=‘X:x:X:x:X:x:X:X/PORT’)
```

In some examples, a natural language interface is provided to a user for the user to ask questions about a codebase. These questions may include a request to perform tasks such as code generation, code summarization, code explanation, knowledge gathering, code debugging, refactoring (optimization), code analysis, etc. To serve such types of natural language queries with higher accuracy, in some examples a summarizer model 203 is used to summarize the chunks (e.g., chunked functions, classes, etc.) in a natural language format. In some examples, the code summarizer model 203 is a generative artificial intelligence model such as a language model. A language model is a type of artificial intelligence (AI) model that is trained on textual data to generate coherent and contextually relevant text. A “large” language model refers to a language model that has been trained on an extensive dataset and has a high number of parameters, enabling them to capture complex language patterns and perform a wider range of tasks. Large language models are designed to handle a wide range of natural language processing tasks, such as text completion, translation, summarization, and even conversation. The specific parameter count required for a model to be considered a “large” language model can vary depending on context and technological advancements. However, traditionally, large language models have millions to billions of parameters.

In some examples, for each code file, chunks are summarized at the function level and at the class level. In some examples, the summarization is done at the file level and then function and class summaries are extracted from that summary.

An example of a function-level chunk is

```
  “ public S3Client provideS3Client(final S3ClientBuilder
  s3ClientBuilder) {\n return
s3ClientBUilder}
```

A summary for this chunk could be “This function 8rovideS3Client′ constructs and returns an S3Client instance using the provided S3ClientBuilder.”

The summaries and chunks are provided to an embedding vector generator 205. In some examples, the embedding vector generator is a semantic embedding model that creates a vector representation for a given text/code. A semantic vector encodes the meaning of the text. Similar text is expected to have a vector embedding that has smaller distance between it and the vector encoded text as compared to vectors for dissimilar texts. Semantic embeddings for the texts can be used to find similar texts based on k-Nearest Neighbor (kNN) search of the vector embeddings. In some examples, the semantic embedding model is a transformer-based model such as a Bidirectional Encoder Representations from Transformers (BERT) model.

An object is created for each chunk with the following fields and indexed using object creator 207 into a vector database 130 using an indexing schema. In some examples, each object includes one more of 1) a code chunk, 2) a summary for the code chunk, 3) an embedding vector for the code chunk, and/or 4) an embedding vector for the summary for the code chunk. The code chunk and its summary may be used for a lexical search. The embedding vectors may be used for semantic searching. Note that a search service may perform the indexing and object creation.

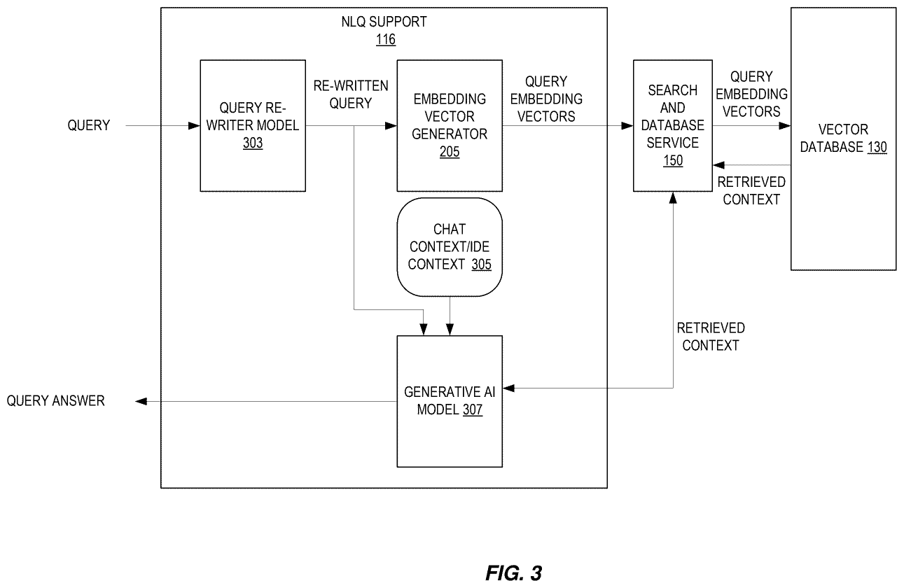

FIG. 3 illustrates examples of generating an answer to a natural language query. In this illustration, a query (e.g., an NLQ) is received from a user. In some examples, the NLQ is received in an IDE 110. A query may be succinct and ambiguous. In some examples, a query re-writer model 303 is used to re-write query based on context. For example, one or more contexts such as project-level context, in-file context, conversation history, etc. may be used to re-write the query. For example, an NLQ of “Provide an example of how to use this library in our codebase?” does not inform the query re-writer model 303 what the “library” is or what the “codebase” is. The query re-writer model 303 would resolve the name of the library and resolve “our codebase” based to a particular project. In some examples, the query re-writer model 303 is a language model. Note that a query may not need to be re-written if sufficiently detailed.

The (re-written) query is passed to an embedding vector generator 205 which has been detailed above. The embedding vector generator 205 generates one or more query embedding vectors (i.e., the embedding vector generator 205 generates a vector for the (re-written) query).

The one or more query embedding vectors are given to a search and database service 150 which uses those vectors to search a vector database 130 for relevant indexed objects for the code repository 120 (e.g., the previously generated and indexed objects). The vector database 130 returns retrieved context.

In some examples, the search service 150 supports a plurality of search types. In some examples, a lexical search is supported. In some examples, a lexical search is based on BM25 match scores (or other scoring methodologies) on the code chunk and summary fields of the stored objects compared to the (re-written) NLQ. In some examples, if there is no summary, then only the comparative score to the code chunk field is used.

In some examples, a semantic search is supported. A KNN vector search is made on the code chunk vectors and/or summary vectors to retrieve a set of “top” documents. KNN similarity scores between the query vector(s) and the top documents is calculated. In some examples, a weighted average is calculated to determine a final score. In some examples, if there is no summary, then only the KNN similarity score to the code chunk field is used.

In some examples, a hybrid search of lexical searching and semantic searching is supported. In some examples, lexical retrieval scores using min-max normalization and a weighted average of the lexical and semantic scores is calculated to determine a final score.

The relevant objects (e.g., top scoring objects) are provided to a generative AI model 307 to predict a query answer. The generative AI model 307 also takes in the (re-written) query and, in some examples, the context 305 such as the IDE context (which may include code) (e.g., if the query is asking about what a particular function, etc. in the code is supposed to represent) and/or chat context (such as previous interactions, etc.). The retrieval of objects for use by the generative AI model 307 may be considered retrieval augmented generation (RAG). RAG retrieves data from outside the language model and augments the prompt (here the NLQ or re-written NLQ) by adding the relevant retrieved data in context. RAG can help reduce model hallucinations by guiding the output to be similar to, or based on, the retrieved information, as opposed to outputs generated purely based on the model parameters that were learned from its training corpus. In some examples, the generative AI model 307 is fine-tuned with other customer data (e.g., not from the enterprise).

In some examples, the generative AI model 307 has a language model context window. A language model context window refers to the range of text that a language model considers when processing or generating a specific word or token within a given sequence of text. It represents the surrounding words or tokens that the model uses to understand the context of the current word or token. The size of this context window is determined by the architecture of the language model. The context window is helpful for language models to generate coherent and contextually accurate responses in various natural language processing tasks, such as text completion, translation, question answering, and more. It enables the model to consider the broader context and semantic meaning of words, ensuring that its output aligns with the input text's intended meaning. The size of this window varies depending on the model but typically includes both preceding and following words in a text sequence. Larger windows may accommodate additional information, such as relevant information added via RAG. However, it's important to note that larger context windows can be computationally expensive, so the size of the context window may vary depending on the specific language model architecture and resource constraints.

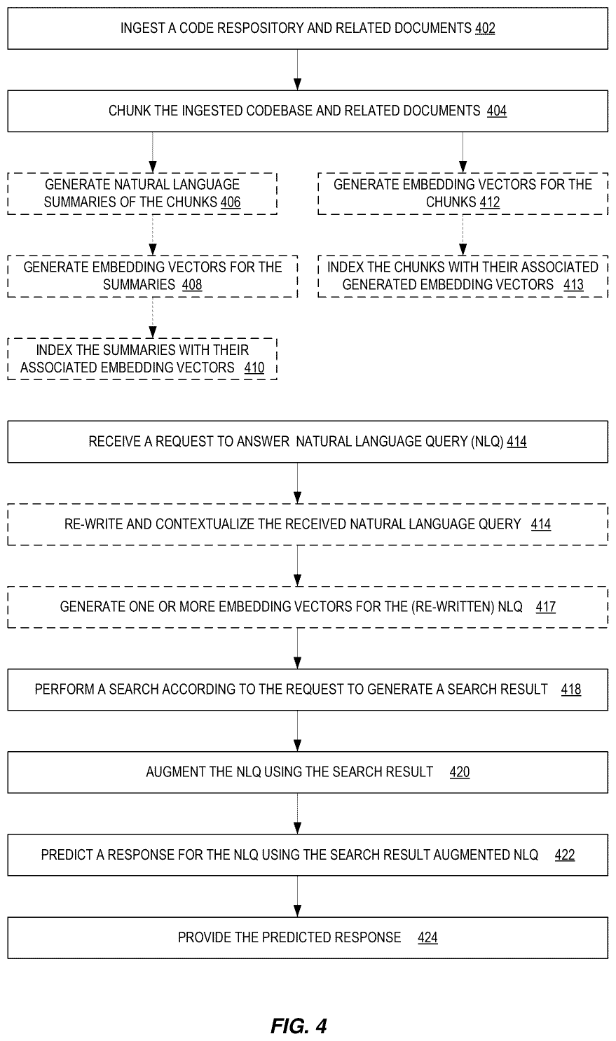

FIG. 4 is a flow diagram illustrating operations of methods for providing a natural language-based chat for coding tasks according to some examples. Some or all of the operations (or other processes described herein, or variations, and/or combinations thereof) are performed under the control of one or more computing devices configured with executable instructions, and are implemented as code (e.g., executable instructions, one or more computer programs, or one or more applications) executing collectively on one or more processors. The code is stored on a computer-readable storage medium, for example, in the form of a computer program comprising instructions executable by one or more processors. The computer-readable storage medium is non-transitory. In some examples, one or more (or all) of the operations are performed by the IDE 110, search service 150, etc. of the other figures.

A codebase and related documents are ingested at 402. The ingesting may clean, transform, transfer, etc. code from the codebase and related documents (such as best practice documents, written descriptions of the codebase, etc.) for use by the IDE 110 in answering NLQ.

The ingested codebase and related documents are chunked at 404. In some examples, the codebase is chunked into function and/or class-level chunks at 404. This type of chunking is document based on the inherent structure of the code. For example, PythonCodeTextSplitter may be used to split Python code along the Python syntax (e.g., split along class and method (function) definitions).

In some examples, natural language summaries of the chunks are generated at 406. For example, one or more language models may be used to generate summaries.

In some examples, embedding vectors for the summaries are generated at 408. In some examples, a language model is used such as a transformer-based model. Non-limiting examples of embedding models include Word2Vec, GET-Base, GLOVE, BERT, GPT, FAISS, etc.

The embedding vectors are indexed with their associated summaries as objects in a vector database at 410 in some examples.

In some examples, embedding vectors for the chunks are generated at 412. In some examples, a language model is used such as a transformer-based model. Non-limiting examples of embedding models include Word2Vec, GET-Base, GLOVE, BERT, GPT, FAISS, etc. Note that in some examples, the embedding model is the same for chunks and summaries.

The chunks are indexed with their associated generated embedding vectors as objects in a vector database at 413. In some examples, a chunk, an embedding vector for the chunk, a summary of the chunk, and an embedding vector for the summary of the chunk are all a part of the same object.

In some examples, related documents and associated embeddings are also stored.

One or more of the above acts may be performed offline. In some examples, as more code is added to the code repository it is ingested, chunked, etc.

A request to answer a natural language query (NLQ) is received at 414. For example, a user may request, via a graphical user interface (GUI) that a NLQ be answered. Examples of NLQs may include “Where are the APIs defined and what are the places where the APIs used?”, “What are the dependencies and libraries used in this project and why are they used?”, “Why do we call <specific function>?”, “Are there any coding standards or style guides followed in this project?”, etc.

In some examples, the received natural language query is re-written and contextualized at 414. For example, the NLQ is re-written to resolve ambiguous names or terms in the NLQ which comes from available context such as a conversational history, the project, information within a file, etc.

One or more embedding vectors for the (re-written) NLQ are generated at 416. In some examples, a language model generates the one or more embedding vectors.

In some examples, one or more embedding vectors for the (re-written NLQ are generated at 417.

A search according to the request is performed to generate a search result at 418. The search may be lexical, semantic, or a combination of both lexical and semantic. The request uses the one or more embedding vectors to search for KNN matches in the vector database.

The NLQ is augmented using the search result at 420. For example, the content of the matches is added to the NLQ. If the NLQ involves identified code, that code may also be added to the NLQ.

A response for the NLQ is made using the search result augmented NLQ at 422. For example, a language model may predict a response with the augmented NLQ as its input.

The predicted response is provided at 424. As shown below, this may be in the for a GUI output.

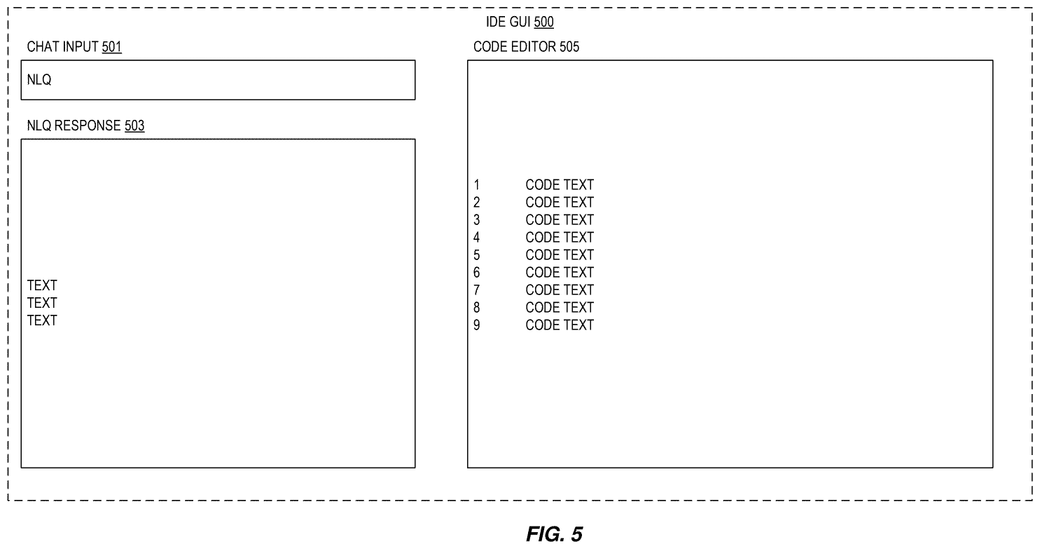

FIG. 5 illustrates examples of a graphical user interface for an IDE. In this illustration, the IDE GUI 500 includes a code editor section 505 that allows a user to edit code in one or more languages. The IDE GUI 500 also includes a chat input 501 that allows a user to input a NLQ which is then handled as detailed above. A result of the handling of the NLW is provided in a NLQ response section 503. In some examples, one or more of the chat input 501 and NLQ response section 503.

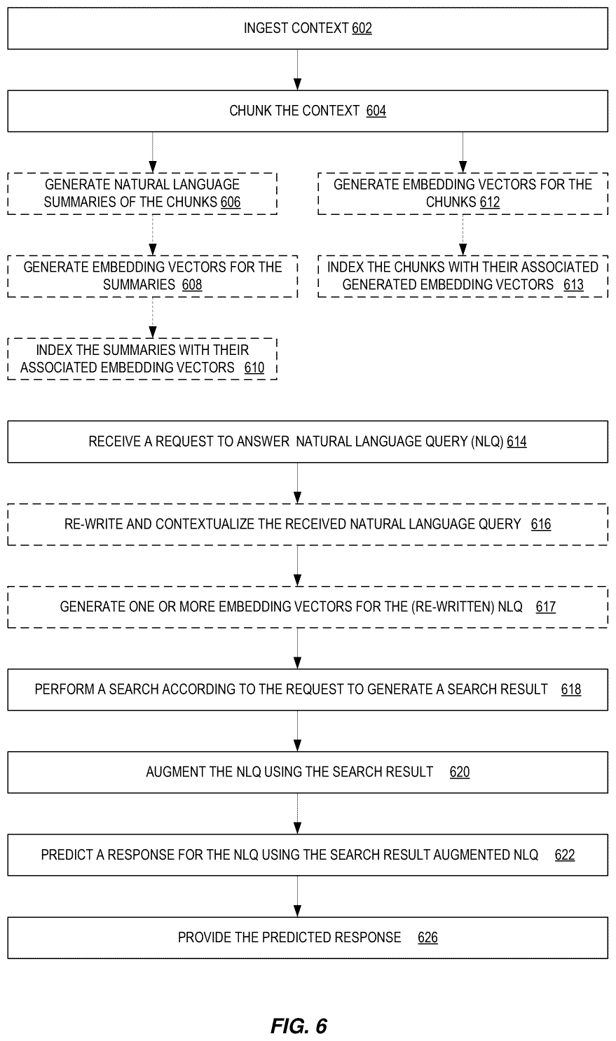

FIG. 6 is a flow diagram illustrating operations of methods for providing a natural language-based chat according to some examples. Some or all of the operations (or other processes described herein, or variations, and/or combinations thereof) are performed under the control of one or more computing devices configured with executable instructions, and are implemented as code (e.g., executable instructions, one or more computer programs, or one or more applications) executing collectively on one or more processors. The code is stored on a computer-readable storage medium, for example, in the form of a computer program comprising instructions executable by one or more processors. The computer-readable storage medium is non-transitory. In some examples, one or more (or all) of the operations are performed by the IDE 110, search service 150, etc. of the other figures.

A context is ingested at 602. The ingesting may clean, transform, transfer, etc. the context.

The ingested context is chunked at 604.

In some examples, natural language summaries of the chunks are generated at 606. For example, one or more language models may be used to generate summaries.

In some examples, embedding vectors for the summaries are generated at 608. In some examples, a language model is used such as a transformer-based model. Non-limiting examples of embedding models include Word2Vec, GET-Base, GLOVE, BERT, GPT, FAISS, etc.

The embedding vectors are indexed with their associated summaries as objects in a vector database at 610 in some examples.

In some examples, embedding vectors for the chunks are generated at 612. In some examples, a language model is used such as a transformer-based model. Non-limiting examples of embedding models include Word2Vec, GET-Base, GLOVE, BERT, GPT, FAISS, etc. Note that in some examples, the embedding model is the same for chunks and summaries.

The chunks are indexed with their associated generated embedding vectors as objects in a vector database at 613. In some examples, a chunk, an embedding vector for the chunk, a summary of the chunk, and an embedding vector for the summary of the chunk are all a part of the same object.

In some examples, related documents and associated embeddings are also stored.

One or more of the above acts may be performed offline.

A request to answer a natural language query (NLQ) is received at 614. For example, a user may request, via a graphical user interface (GUI) that a NLQ be answered. Examples of NLQs may include “Where are the APIs defined and what are the places where the APIs used?”, “What are the dependencies and libraries used in this project and why are they used?”, “Why do we call <specific function>?”, “Are there any coding standards or style guides followed in this project?”, etc.

In some examples, the received natural language query is re-written and contextualized at 616. For example, the NLQ is re-written to resolve ambiguous names or terms in the NLQ which comes from available context such as a conversational history, the project, information within a file, etc.

One or more embedding vectors for the (re-written) NLQ are generated at 616. In some examples, a language model generates the one or more embedding vectors.

In some examples, one or more embedding vectors for the (re-written NLQ are generated at 617.

A search according to the request is performed to generate a search result at 618. The search may be lexical, semantic, or a combination of both lexical and semantic. The request uses the one or more embedding vectors to search for KNN matches in the vector database.

The NLQ is augmented using the search result at 620. For example, the content of the matches is added to the NLQ. If the NLQ involves identified code, that code may also be added to the NLQ.

A response for the NLQ is made using the search result augmented NLQ at 622. For example, a language model may predict a response with the augmented NLQ as its input.

The predicted response is provided at 624. As shown below, this may be in the for a GUI output.

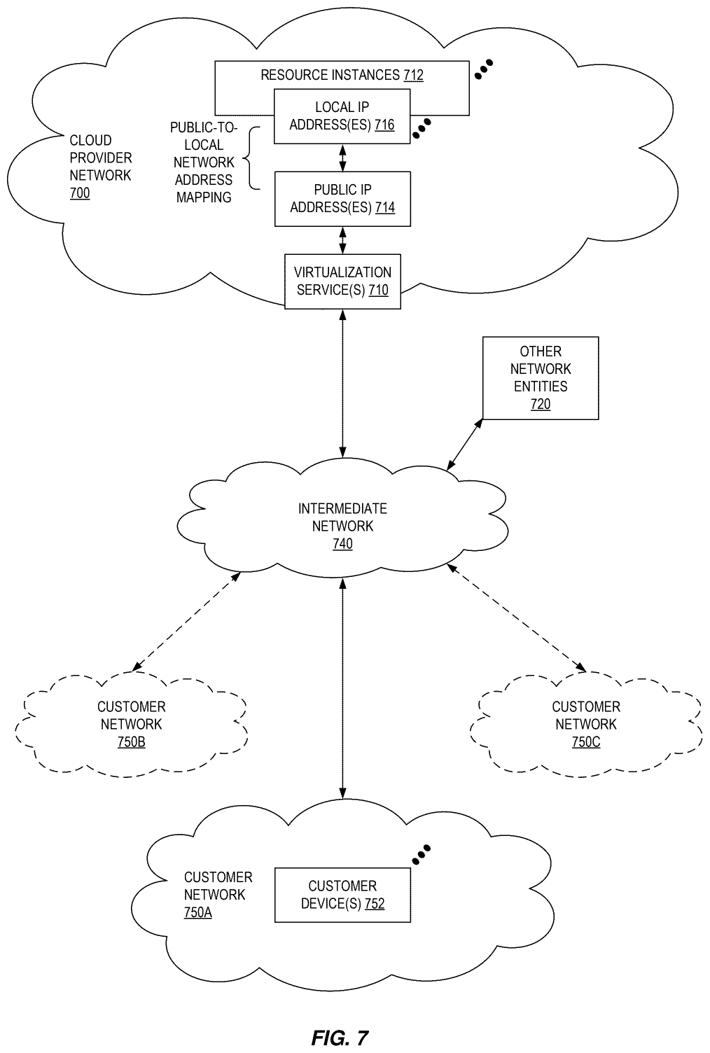

FIG. 7 illustrates an example provider network (or “service provider system”) environment according to some examples. A provider network 700 can provide resource virtualization to customers via one or more virtualization services 710 that allow customers to purchase, rent, or otherwise obtain instances 712 of virtualized resources, including but not limited to computation and storage resources, implemented on devices within the provider network or networks in one or more data centers. Local Internet Protocol (IP) addresses 716 can be associated with the resource instances 712; the local IP addresses are the internal network addresses of the resource instances 712 on the provider network 700. In some examples, the provider network 700 can also provide public IP addresses 714 and/or public IP address ranges (e.g., Internet Protocol version 4 (IPv4) or Internet Protocol version 6 (IPv6) addresses) that customers can obtain from the provider 700.

Conventionally, the provider network 700, via the virtualization services 710, can allow a customer of the service provider (e.g., a customer that operates one or more customer networks 750A-750C (or “client networks”) including one or more customer device(s) 752) to dynamically associate at least some public IP addresses 714 assigned or allocated to the customer with particular resource instances 712 assigned to the customer. The provider network 700 can also allow the customer to remap a public IP address 714, previously mapped to one virtualized computing resource instance 712 allocated to the customer, to another virtualized computing resource instance 712 that is also allocated to the customer. Using the virtualized computing resource instances 712 and public IP addresses 714 provided by the service provider, a customer of the service provider such as the operator of the customer network(s) 750A-750C can, for example, implement customer-specific applications and present the customer's applications on an intermediate network 740, such as the Internet. Other network entities 720 on the intermediate network 740 can then generate traffic to a destination public IP address 714 published by the customer network(s) 750A-750C; the traffic is routed to the service provider data center, and at the data center is routed, via a network substrate, to the local IP address 716 of the virtualized computing resource instance 712 currently mapped to the destination public IP address 714. Similarly, response traffic from the virtualized computing resource instance 712 can be routed via the network substrate back onto the intermediate network 740 to the source entity 720.

Local IP addresses, as used herein, refer to the internal or “private” network addresses, for example, of resource instances in a provider network. Local IP addresses can be within address blocks reserved by Internet Engineering Task Force (IETF) Request for Comments (RFC) 1918 and/or of an address format specified by IETF RFC 4193 and can be mutable within the provider network. Network traffic originating outside the provider network is not directly routed to local IP addresses; instead, the traffic uses public IP addresses that are mapped to the local IP addresses of the resource instances. The provider network can include networking devices or appliances that provide network address translation (NAT) or similar functionality to perform the mapping from public IP addresses to local IP addresses and vice versa.

Public IP addresses are Internet mutable network addresses that are assigned to resource instances, either by the service provider or by the customer. Traffic routed to a public IP address is translated, for example via 1:1 NAT, and forwarded to the respective local IP address of a resource instance.

Some public IP addresses can be assigned by the provider network infrastructure to particular resource instances; these public IP addresses can be referred to as standard public IP addresses, or simply standard IP addresses. In some examples, the mapping of a standard IP address to a local IP address of a resource instance is the default launch configuration for all resource instance types.

At least some public IP addresses can be allocated to or obtained by customers of the provider network 700; a customer can then assign their allocated public IP addresses to particular resource instances allocated to the customer. These public IP addresses can be referred to as customer public IP addresses, or simply customer IP addresses. Instead of being assigned by the provider network 700 to resource instances as in the case of standard IP addresses, customer IP addresses can be assigned to resource instances by the customers, for example via an API provided by the service provider. Unlike standard IP addresses, customer IP addresses are allocated to customer accounts and can be remapped to other resource instances by the respective customers as necessary or desired. A customer IP address is associated with a customer's account, not a particular resource instance, and the customer controls that IP address until the customer chooses to release it. Unlike conventional static IP addresses, customer IP addresses allow the customer to mask resource instance or availability zone failures by remapping the customer's public IP addresses to any resource instance associated with the customer's account. The customer IP addresses, for example, enable a customer to engineer around problems with the customer's resource instances or software by remapping customer IP addresses to replacement resource instances.

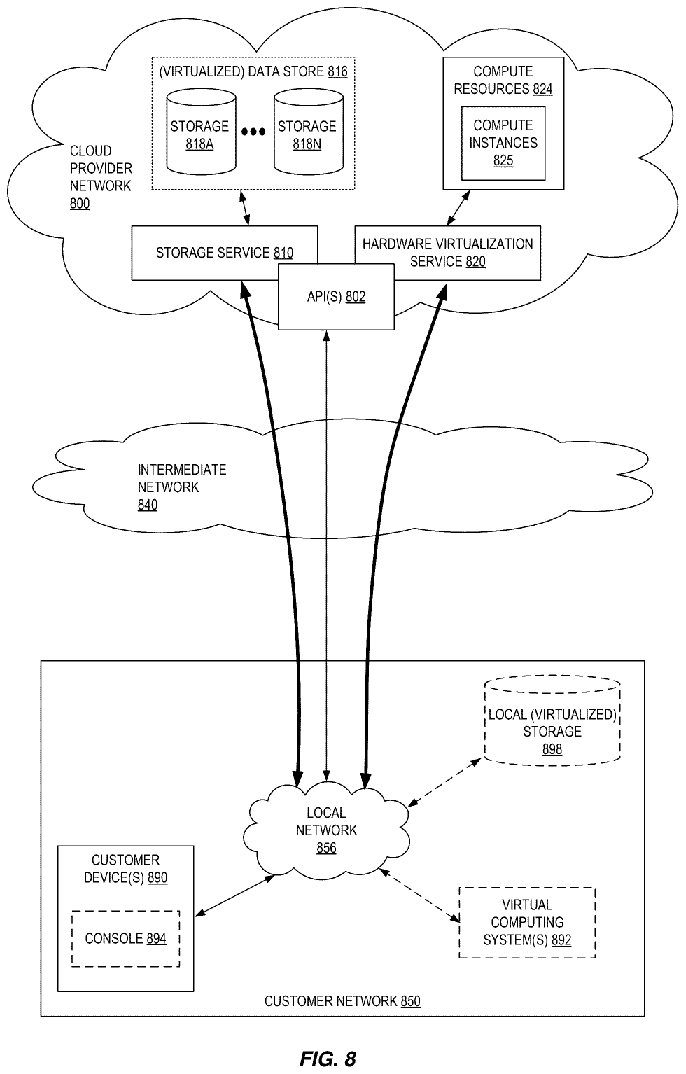

FIG. 8 is a block diagram of an example provider network environment that provides a storage service and a hardware virtualization service to users, according to some examples. A hardware virtualization service 820 provides multiple compute resources 824 (e.g., compute instances 825, such as VMs) to users. The compute resources 824 can, for example, be provided as a service to users (or “customers”) of a provider network 800 (e.g., to a customer that implements a customer network 850). Each computation resource 824 can be provided with one or more local IP addresses. The provider network 800 can be configured to route packets from the local IP addresses of the compute resources 824 to public Internet destinations, and from public Internet sources to the local IP addresses of the compute resources 824.

The provider network 800 can provide the customer network 850, for example coupled to an intermediate network 840 via a local network 856, the ability to implement virtual computing systems 892 via the hardware virtualization service 820 coupled to the intermediate network 840 and to the provider network 800. In some examples, the hardware virtualization service 820 can provide one or more APIs 802, for example a web services interface, via which the customer network 850 can access functionality provided by the hardware virtualization service 820, for example via a console 894 (e.g., a web-based application, standalone application, mobile application, etc.) of a customer device 890. In some examples, at the provider network 800, each virtual computing system 892 at the customer network 850 can correspond to a computation resource 824 that is leased, rented, or otherwise provided to the customer network 850.

From an instance of the virtual computing system(s) 892 and/or another customer device 890 (e.g., via console 894), the customer can access the functionality of a storage service 810, for example via the one or more APIs 802, to access data from and store data to storage resources 818A-818N of a virtual data store 816 (e.g., a folder or “bucket,” a virtualized volume, a database, etc.) provided by the provider network 800. In some examples, a virtualized data store gateway (not shown) can be provided at the customer network 850 that can locally cache at least some data, for example frequently accessed or critical data, and that can communicate with the storage service 810 via one or more communications channels to upload new or modified data from a local cache so that the primary store of data (the virtualized data store 816) is maintained. In some examples, a user, via the virtual computing system 892 and/or another customer device 890, can mount and access virtual data store 816 volumes via the storage service 810 acting as a storage virtualization service, and these volumes can appear to the user as local (virtualized) storage 898.

While not shown in FIG. 8, the virtualization service(s) can also be accessed from resource instances within the provider network 800 via the API(s) 802. For example, a customer, appliance service provider, or other entity can access a virtualization service from within a respective virtual network on the provider network 800 via the API(s) 802 to request allocation of one or more resource instances within the virtual network or within another virtual network.

### Illustrative Systems

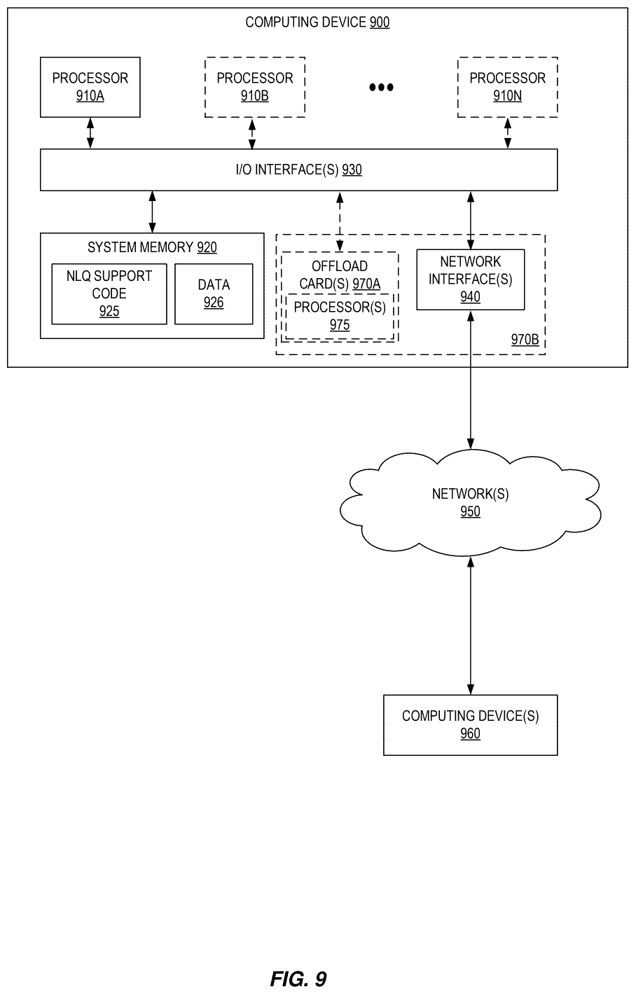

In some examples, a system that implements a portion or all of the techniques described herein can include a general-purpose computer system, such as the computing device 900 (also referred to as a computing system or electronic device) illustrated in FIG. 9, that includes, or is configured to access, one or more computer-accessible media. In the illustrated example, the computing device 900 includes one or more processors 910 coupled to a system memory 920 via an input/output (I/O) interface 930. The computing device 900 further includes a network interface 940 coupled to the I/O interface 930. While FIG. 9 shows the computing device 900 as a single computing device, in various examples the computing device 900 can include one computing device or any number of computing devices configured to work together as a single computing device 900.

In various examples, the computing device 900 can be a uniprocessor system including one processor 910, or a multiprocessor system including several processors 910 (e.g., two, four, eight, or another suitable number). The processor(s) 910 can be any suitable processor(s) capable of executing instructions. For example, in various examples, the processor(s) 910 can be general-purpose or embedded processors implementing any of a variety of instruction set architectures (ISAs), such as the x86, ARM, PowerPC, SPARC, or MIPS ISAs, or any other suitable ISA. In multiprocessor systems, each of the processors 910 can commonly, but not necessarily, implement the same ISA.

The system memory 920 can store instructions and data accessible by the processor(s) 910. In various examples, the system memory 920 can be implemented using any suitable memory technology, such as random-access memory (RAM), static RAM (SRAM), synchronous dynamic RAM (SDRAM), nonvolatile/Flash-type memory, or any other type of memory. In the illustrated example, program instructions and data implementing one or more desired functions, such as those methods, techniques, and data described above, are shown stored within the system memory 920 as NLQ support code 925 (e.g., executable to implement, in whole or in part, the NLQ chat support 116(A) or 116(B)) and data 926.

In some examples, the I/O interface 930 can be configured to coordinate I/O traffic between the processor 910, the system memory 920, and any peripheral devices in the device, including the network interface 940 and/or other peripheral interfaces (not shown). In some examples, the I/O interface 930 can perform any necessary protocol, timing, or other data transformations to convert data signals from one component (e.g., the system memory 920) into a format suitable for use by another component (e.g., the processor 910). In some examples, the I/O interface 930 can include support for devices attached through various types of peripheral buses, such as a variant of the Peripheral Component Interconnect (PCI) bus standard or the Universal Serial Bus (USB) standard, for example. In some examples, the function of the I/O interface 930 can be split into two or more separate components, such as a north bridge and a south bridge, for example. Also, in some examples, some or all of the functionality of the I/O interface 930, such as an interface to the system memory 920, can be incorporated directly into the processor 910.

The network interface 940 can be configured to allow data to be exchanged between the computing device 900 and other computing devices 960 attached to a network or networks 950, such as other computer systems or devices as illustrated in FIG. 1, for example. In various examples, the network interface 940 can support communication via any suitable wired or wireless general data networks, such as types of Ethernet network, for example. Additionally, the network interface 940 can support communication via telecommunications/telephony networks, such as analog voice networks or digital fiber communications networks, via storage area networks (SANs), such as Fibre Channel SANs, and/or via any other suitable type of network and/or protocol.

In some examples, the computing device 900 includes one or more offload cards 970A or 970B (including one or more processors 975, and possibly including the one or more network interfaces 940) that are connected using the I/O interface 930 (e.g., a bus implementing a version of the Peripheral Component Interconnect-Express (PCI-E) standard, or another interconnect such as a QuickPath interconnect (QPI) or UltraPath interconnect (UPI)). For example, in some examples the computing device 900 can act as a host electronic device (e.g., operating as part of a hardware virtualization service) that hosts compute resources such as compute instances, and the one or more offload cards 970A or 970B execute a virtualization manager that can manage compute instances that execute on the host electronic device. As an example, in some examples the offload card(s) 970A or 970B can perform compute instance management operations, such as pausing and/or un-pausing compute instances, launching and/or terminating compute instances, performing memory transfer/copying operations, etc. These management operations can, in some examples, be performed by the offload card(s) 970A or 970B in coordination with a hypervisor (e.g., upon a request from a hypervisor) that is executed by the other processors 910A-910N of the computing device 900. However, in some examples the virtualization manager implemented by the offload card(s) 970A or 970B can accommodate requests from other entities (e.g., from compute instances themselves), and cannot coordinate with (or service) any separate hypervisor.

In some examples, the system memory 920 can be one example of a computer-accessible medium configured to store program instructions and data as described above. However, in other examples, program instructions and/or data can be received, sent, or stored upon different types of computer-accessible media. Generally, a computer-accessible medium can include any non-transitory storage media or memory media such as magnetic or optical media, e.g., disk or DVD/CD coupled to the computing device 900 via the I/O interface 930. A non-transitory computer-accessible storage medium can also include any volatile or non-volatile media such as RAM (e.g., SDRAM, double data rate (DDR) SDRAM, SRAM, etc.), read only memory (ROM), etc., that can be included in some examples of the computing device 900 as the system memory 920 or another type of memory. Further, a computer-accessible medium can include transmission media or signals such as electrical, electromagnetic, or digital signals, conveyed via a communication medium such as a network and/or a wireless link, such as can be implemented via the network interface 940.

Various examples discussed or suggested herein can be implemented in a wide variety of operating environments, which in some cases can include one or more user computers, computing devices, or processing devices which can be used to operate any of a number of applications. User or client devices can include any of a number of general-purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems, and/or other devices capable of communicating via a network.

Most examples use at least one network that would be familiar to those skilled in the art for supporting communications using any of a variety of widely available protocols, such as Transmission Control Protocol/Internet Protocol (TCP/IP), File Transfer Protocol (FTP), Universal Plug and Play (UPnP), Network File System (NFS), Common Internet File System (CIFS), Extensible Messaging and Presence Protocol (XMPP), AppleTalk, etc. The network(s) can include, for example, a local area network (LAN), a wide-area network (WAN), a virtual private network (VPN), the Internet, an intranet, an extranet, a public switched telephone network (PSTN), an infrared network, a wireless network, and any combination thereof.

In examples using a web server, the web server can run any of a variety of server or mid-tier applications, including HTTP servers, File Transfer Protocol (FTP) servers, Common Gateway Interface (CGI) servers, data servers, Java servers, business application servers, etc. The server(s) also can be capable of executing programs or scripts in response requests from user devices, such as by executing one or more Web applications that can be implemented as one or more scripts or programs written in any programming language, such as Java®, C, C# or C++, or any scripting language, such as Perl, Python, PHP, or TCL, as well as combinations thereof. The server(s) can also include database servers, including without limitation those commercially available from Oracle®, Microsoft®, Sybase®, IBM®, etc. The database servers can be relational or non-relational (e.g., “NoSQL”), distributed or non-distributed, etc.

Environments disclosed herein can include a variety of data stores and other memory and storage media as discussed above. These can reside in a variety of locations, such as on a storage medium local to (and/or resident in) one or more of the computers or remote from any or all of the computers across the network. In a particular set of examples, the information can reside in a storage-area network (SAN) familiar to those skilled in the art. Similarly, any necessary files for performing the functions attributed to the computers, servers, or other network devices can be stored locally and/or remotely, as appropriate. Where a system includes computerized devices, each such device can include hardware elements that can be electrically coupled via a bus, the elements including, for example, at least one central processing unit (CPU), at least one input device (e.g., a mouse, keyboard, controller, touch screen, or keypad), and/or at least one output device (e.g., a display device, printer, or speaker). Such a system can also include one or more storage devices, such as disk drives, optical storage devices, and solid-state storage devices such as random-access memory (RAM) or read-only memory (ROM), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or web browser. It should be appreciated that alternate examples can have numerous variations from that described above. For example, customized hardware might also be used and/or particular elements might be implemented in hardware, software (including portable software, such as applets), or both. Further, connection to other computing devices such as network input/output devices can be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, Electrically Erasable Programmable Read-Only Memory (EEPROM), flash memory or other memory technology, Compact Disc-Read Only Memory (CD-ROM), Digital Versatile Disk (DVD) or other optical storage, magnetic cassettes, magnetic tape, magnetic disk storage or other magnetic storage devices, or any other medium which can be used to store the desired information and which can be accessed by a system device. Based on the disclosure and teachings provided herein, a person of ordinary skill in the art will appreciate other ways and/or methods to implement the various examples.

In the preceding description, various examples are described. For purposes of explanation, specific configurations and details are set forth to provide a thorough understanding of the examples. However, it will also be apparent to one skilled in the art that the examples can be practiced without the specific details. Furthermore, well-known features can be omitted or simplified in order not to obscure the example being described.

Bracketed text and blocks with dashed borders (e.g., large dashes, small dashes, dot-dash, and dots) are used herein to illustrate optional aspects that add additional features to some examples. However, such notation should not be taken to mean that these are the only options or optional operations, and/or that blocks with solid borders are not optional in certain examples.

Reference numerals with suffix letters (e.g., 818A-818N) can be used to indicate that there can be one or multiple instances of the referenced entity in various examples, and when there are multiple instances, each does not need to be identical but may instead share some general traits or act in common ways. Further, the particular suffixes used are not meant to imply that a particular amount of the entity exists unless specifically indicated to the contrary. Thus, two entities using the same or different suffix letters might or might not have the same number of instances in various examples.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” is intended to be understood to mean either A, B, or C, or any combination thereof (e.g., A, B, and/or C). Similarly, language such as “at least one or more of A, B, and C” (or “one or more of A, B, and C”) is intended to be understood to mean A, B, or C, or any combination thereof (e.g., A, B, and/or C). As such, disjunctive language is not intended to, nor should it be understood to, imply that a given example requires at least one of A, at least one of B, and at least one of C to each be present.

As used herein, the term “based on” (or similar) is an open-ended term used to describe one or more factors that affect a determination or other action. It is to be understood that this term does not foreclose additional factors that may affect a determination or action. For example, a determination may be solely based on the factor(s) listed or based on the factor(s) and one or more additional factors. Thus, if an action A is “based on” B, it is to be understood that B is one factor that affects action A, but this does not foreclose the action from also being based on one or multiple other factors, such as factor C. However, in some instances, action A may be based entirely on B.

Unless otherwise explicitly stated, articles such as “a” or “an” should generally be interpreted to include one or multiple described items. Accordingly, phrases such as “a device configured to” or “a computing device” are intended to include one or multiple recited devices. Such one or more recited devices can be collectively configured to carry out the stated operations. For example, “a processor configured to carry out operations A, B, and C” can include a first processor configured to carry out operation A working in conjunction with a second processor configured to carry out operations B and C, where the second processor could be part of same computing device as the first processor or part of a separate computing device as the first processor.

Further, the words “may” or “can” are used in a permissive sense (i.e., meaning having the potential to), rather than the mandatory sense (i.e., meaning must). The words “include,” “including,” and “includes” are used to indicate open-ended relationships and therefore mean including, but not limited to. Similarly, the words “have,” “having,” and “has” also indicate open-ended relationships, and thus mean having, but not limited to. The terms “first,” “second,” “third,” and so forth as used herein are used as labels for the nouns that they precede, and do not imply any type of ordering (e.g., spatial, temporal, logical, etc.) unless such an ordering is otherwise explicitly indicated. Similarly, the values of such numeric labels are generally not used to indicate a required amount of a particular noun in the claims recited herein, and thus a “fifth” element generally does not imply the existence of four other elements unless those elements are explicitly included in the claim or it is otherwise made abundantly clear that they exist.

The specification and drawings are, accordingly, to be regarded in an illustrative rather than a restrictive sense. It will, however, be evident that various modifications and changes can be made thereunto without departing from the broader scope of the disclosure as set forth in the claims.

What is claimed is:

1. A computer-implemented method comprising:
generating an index of a codebase by at least (i) chunking source code of the codebase to extract function-level and class-level code chunks, (ii) generating respective natural language summaries of the code chunks, (iii) creating respective semantic vector embeddings of the code chunks and the natural language summaries, and (iv) storing the code chunks and the respective natural language summaries and respective semantic vector embeddings in a search index;
receiving, from a user, a natural language query (NLQ) about the codebase in a chat interface an integrated development environment;
generating one or more embedding vectors for the NLQ;
performing multi-strategy retrieval on the index of the codebase using the one or more embedding vectors for the NLQ, wherein the multi-strategy retrieval includes performing lexical search on the code chunks and natural language summaries and semantic search on the vector embeddings, and combining results from the lexical and semantic searches using hybrid scoring;
retrieving particular ones of the code chunks and their respective natural language summaries based on the hybrid scoring;
generating a response to the NLQ using a prompt to a language model that has been augmented with the retrieved code chunks and their respective natural language summaries; and
providing the response to the user via the chat interface.

2. The computer-implemented method of claim 1, further comprising:
using contextual information to re-write the received natural language query.

3. The computer-implemented method of claim 1, wherein the NLQ is a request to perform one or more of providing explanation of a segment of code using contextual information, performing code refactoring, performing knowledge gathering, performing code analysis, generating code using contextual information, and/or performing code debugging.

4. A computer-implemented method comprising:
receiving a request to answer a natural language query (NLQ);
generating one or more embedding vectors for the NLQ;
performing a search of a vector database having information regarding one or more of enterprise context, natural language summaries of enterprise context, embedding vectors for the enterprise context, and embedding vectors for natural language summaries of the enterprise context according to the request to generate a search result;
augmenting the NLQ using the search result;
predicting a response for the NLQ using the search result augmented NLQ; and
providing the predicted response.

5. The computer-implemented method of claim 4, further comprising:
using contextual information to re-write the received natural language query.

6. The computer-implemented method of claim 4, wherein the performing a search of a vector database having information regarding one or more of enterprise context, natural language summaries of the enterprise context, embedding vectors for the enterprise context, and embedding vectors for natural language summaries of the enterprise context according to the request to generate a search result comprises performing a lexical search on the code and related documents of the enterprise context and natural language summaries of the enterprise context.

7. The computer-implemented method of claim 4, wherein the performing a search of a vector database having information regarding one or more of enterprise context, natural language summaries of the enterprise context, embedding vectors for the enterprise context, and embedding vectors for natural language summaries of the enterprise context according to the request to generate a search result comprises performing a semantic search on the embedding vectors for the enterprise context and embedding vectors for natural language summaries of the enterprise context.

8. The computer-implemented method of claim 4, wherein the performing a search of a vector database having information regarding one or more of enterprise context, natural language summaries of the enterprise context, embedding vectors for the enterprise context, and embedding vectors for natural language summaries of the enterprise context according to the request to generate a search result comprises performing a lexical search and a semantic search.

9. The computer-implemented method of claim 4, wherein the NLQ is a request to generate code using contextual information.

10. The computer-implemented method of claim 4, wherein the NLQ is a request to explain a segment of code using contextual information.

11. The computer-implemented method of claim 4, wherein the NLQ is a request to perform code debug.

12. The computer-implemented method of claim 4, wherein the NLQ is received via an integrated development environment (IDE).

13. The computer-implemented method of claim 4, further comprising:
ingesting the code repository and related documents;
chunking the ingested code repository into function and/or class-level chunks;
generating natural language summaries of the chunks using a first machine learning model;
generating embedding vectors for the chunks using a second machine learning model;
generating embedding vectors for the chunks using the second using a machine learning model;
indexing the chunks with their associated generated embedding vectors into a vector database; and
indexing the chunks with their associated summaries into the vector database.

14. The computer-implemented method of claim 13, wherein the vector database is maintained by a search and database service.

15. The computer-implemented method of claim 4, wherein predicting a response for the NLQ using the search result augmented NLQ is to be performed using a model fine-tuned on aspects of the enterprise context.

16. The computer-implemented method of claim 4, wherein the enterprise context at least includes code and documents related to the code.

17. A system comprising:
a first one or more computing devices to implement a storage service in a multi-tenant provider network; and
a second one or more computing devices to implement a natural language query service in the multi-tenant provider network, the natural language query service including instructions that upon execution cause the natural language query service to:
receive a request to answer a natural language query (NLQ);
generate one or more embedding vectors for the NLQ;
perform a search of a vector database having information regarding one or more of enterprise context, natural language summaries of enterprise context, embedding vectors for the enterprise context, and embedding vectors for natural language summaries of the enterprise context according to the request to generate a search result;
augment the NLQ using the search result;
predict a response for the NLQ using the search result augmented NLQ; and
provide the predicted response.

18. The system of claim 17, wherein the NLQ is a request to perform code refactoring.

19. The system of claim 17, wherein the NLQ is a request to perform knowledge gathering.

20. The system of claim 17, wherein the NLQ is a request to perform code analysis.
